(19) United States
(12) Patent Application Publication
(10) Pub. No.: US 2002/0033417 A1
(43) Pub. Date: Mar. 21, 2002

(54) Card reader integrated financial services and the operating method thereof

(76) Inventor: Jae-Sung Jeon, Seoul (KR)

Correspondence Address: NATH & ASSOCIATES PLLC, Sixth Floor, 1030 Fifteenth Street, N.W., Washington, DC, 20005, US

(21) Appl. No.: 09/822,182

(22) Filed: Apr. 2, 2001

(30) Foreign Application Priority Data
Sep. 16, 2000 (KR) 2000-54474

(51) Int. Cl. G06K 5/00

(52) U.S. Cl. 235/380

(57) ABSTRACT

The present invention discloses a card reader integrated financial services. According to the card reader integrated financial services and the operating method in which a credit card business using a credit card, businesses such as remittance of the price of goods and payment of money using a cash card and business for the use of electronic money can be performed and a user can receive the money, that is, a cash service, remitted to the account of the joint store without visiting a bank.

### BACKGROUND OF THE INVENTION

1. Field of the Invention

The present invention relates to a card reader integrated financial services and the operating method thereof, and in particular to a card reader integrated financial services and the operating method thereof in which a credit card business using a credit card, businesses such as remittance of the price of goods and payment of money using a cash card and a business for using electronic money can be performed.

2. Description of the Background Art

A card reader is an apparatus for reading contents recorded on a card and mounted on an EFT-POS system, an entrance and exit control reader, a financial terminal, a web videophone, and a screen phone etc. According to the kind of cards, there are many cards such as a smart card, a magnetic tape card, and a non-contact type card, and there are many card readers such as a smart card reader, a magnetic tape card reader, and a non-contact type card reader for reading data recorded to the cards according to the kind of cards.

As above, among the various kind of card readers, the present invention deals with a card reader related to financial services.

Generally, in a case of a card reader mounted at a joint store, a magnetic tape card reader has been used for using a credit card or a cash card.

Accordingly, after a purchaser buys goods at a joint store using a credit card or a cash card, in a case that the purchaser presents a credit card for payment of the price of goods, card information stored to the credit card and information relating to the price of goods, the number of months of payment by installment, and the joint store through the card reader are transmitted to the company of the credit card through a VAN company, and then information transmitted from the credit card company is outputted and so the result of processing is informed to the purchaser.

However, in the credit card, by the rule of IS08583, various information must be recorded to the track II of a magnetic tape, a card reader mounted at the joint store scans only the track II for reading information recorded to the credit card.

Accordingly, when performing financial services through the card reader of the joint store, having a cash card of a bank disclosed at the Korean patent application number of 2000-978(filed on Jan. 10, 2000), “method of processing settlement of money in real time through a cash card”, which has been filed by the same applicant of the present invention, there are disadvantages that since the card reader, for only the credit card, only can read the track II of the credit card, the card reader not only can not read information stored to the track III of a magnetic tape, but also can not perform financial services using a cash card.

On the other hand, there is also a disadvantage that when using an IC card being used as an electronic money, that is, a smart card, the electronic money cannot be used through the card reader, which only can read a magnetic tape card.

### SUMMARY OF THE INVENTION

Accordingly, it is an object of the present invention to provide a card reader integrated financial services and the operating method thereof in which a credit card business using a credit card, businesses such as remittance of the price of goods and payment of money using a cash card and a business for using electronic money can be performed.

In order to achieve the above-described object of one aspect of the present invention, a card reader integrated financial services, comprises a card reader integrated financial services comprising: an IC card interface unit for communicating with an IC card each other, a MS card interface unit for reading data recorded on a MS card, a key input unit for inputting a key in order to select or operate a menu, a pin pad for inputting a secret number by users in direct, a storage unit for storing information on a card and a joint store, information exchanged with a host and particulars of dealing, a security module unit for performing storage of a security key and operation of a password, a printer for outputting the particulars of dealing, a display unit for displaying a state of operation, a control unit not only for storing temporarily information on a card read from the IC card and MS card interface units to the storage unit according to values inputted from the key input unit and the pin pad, but also for processing the values stored to the storage unit and the security module and then transmitting it to the host, and for outputting information transmitted from the host to the printer and the display unit, and a modem for connecting the control unit with the host through a telecommunication network, thereby capable of exchanging information.

And, the card reader further comprises: a RS232C interface unit for connecting the control unit with a machine of a check inquiry, a moneybox, and an external device.

And, in the card reader integrated financial services, the display unit includes a first display unit for displaying an operational state of the control unit to an officer of a joint store, a second displaying unit for displaying an operational state of the control unit to a user, thereby capable of identifying contents relating to one easily.

In an another aspect of the present invention, a method for operating a card reader integrated financial services comprising: a step of initializing the card reader, a step of selecting desirable dealings through a key input unit after initializing the card reader, a step of constructing a whole sentence, in a case that a credit card dealing is selected after initializing the card reader, through data of track II of the credit card, of a storage unit and inputted by the key input unit in order to perform dealings such as a purchasing of goods and a cash service, a step of constructing a whole sentence, in a case that a cash card dealing is selected after initializing the card reader, through data of track III of the cash card, of a storage unit and inputted by the key input unit in order to perform dealings such as a remittance of the price of goods and draw money, a step of transmitting the constructed whole sentence to a host through a modem in order to perform dealings such as the credit and cash cards, a step of displaying the result of dealing to a display unit and outputting it to a printer by receiving the data transmitted from the host, a step of calculating, in a case that an electronic money dealing is selected after initializing the card reader, the value of the electronic money through data of the electronic money, a security module, and the key input unit, and collecting the particulars of dealing, a step of automatically transmitting the particulars of dealing in a case that the number of collected particulars of dealings exceeds the maximum collecting matters.

And, in the method for operating a card reader integrated financial services, when transmitting the particulars of dealing, the user can transmit it optionally.

And, the method for operating a card reader integrated financial services, when transmitting the particulars of dealing, further comprises: a step of authenticating reciprocally between the security module of the card reader and the host, a step of comparing that whether there is a direction for updating a parameter of the security module from the host, a step of, if there is a direction for updating a parameter, performing a data transmit-receive operation between the security module of the card reader and the host for updating a parameter, updating the parameter and thereafter returning the process to the authentication step, if there is not the direction for updating the parameter, performing a data transmit-receive operation the particulars of total dealing by the electronic money collected to the security module and the particulars of the respective matters, and a step of outputting the collected particulars of dealing through a printer and then initializing the matters collected to the security module.

And, in the method for operating a card reader integrated financial services, in a case that the user selects optionally the parameter update, the work for updating the parameter of the security module can be performed.

And, the method for operating a card reader integrated financial services, when selecting an electronic money dealing, further comprises: a step for inquiry the state of particulars of the electronic money dealing collected to the KFTC(Korea Financial Telecommunications and Clearings institute).

The above-constructed card reader of the present invention supports dealings of an IC card used as electronic money and a MS card such as a credit card and a cash card. In particular, besides a conventional credit card business, the present invention supports payment of price of goods, remittance, drawing money services etc. by using a cash card, perform without visiting a bank and also provides various menu such as payment, a fault correction in manipulation/a recovery, a transmission of particulars of dealing, a parameter update etc. for using electronic money. According to the present invention, a credit card and cash card dealings can be processed and a dealing using electronic money also can be processed through one card reader.

### BRIEF DESCRIPTION OF THE DRAWINGS

The present invention will become better understood with reference to the accompanying drawings, which are given only by way of illustration and thus are not limitative of the present invention, wherein:

FIG. 1 is a block diagram illustrating a card reader integrated financial services in accordance with the present invention,

FIGS. 2a to 2b are flow charts for explaining an operation of a card reader integrated financial services in accordance with the present invention,

FIG. 3 is a flow chart for explaining transmission of particulars of dealings when dealing electronic money in a credit card integrated financial services in accordance with the present invention,

FIG. 4 is a flow chart for inquiring a state of particulars of dealings when dealing electronic money in a card reader integrated financial services in accordance with the present invention.

### DETAILED DESCRIPTION OF THE PREFERRED EMBODIMENTS

A card reader integrated financial services in accordance with a preferred embodiment of the present invention will now be described with reference to the accompanying drawings.

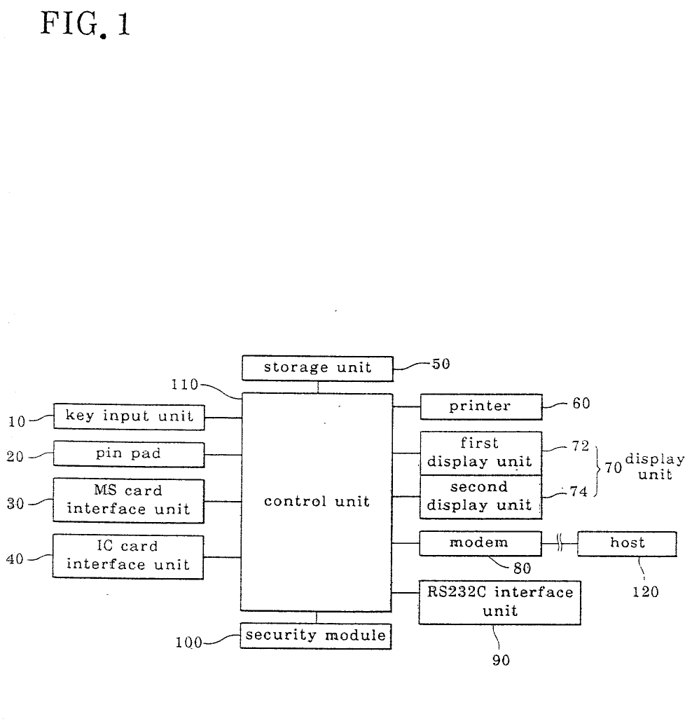

FIG. 1 is a block diagram illustrating a card reader integrated financial services in accordance with the present invention.

As shown in FIG. 1, the card reader integrated financial services includes an IC card interface unit 40 for communicating with an IC card each other, a MS card interface unit 30 for reading data recorded on the MS card, a key input unit 10 for inputting a key in order to select or operate a menu, a pin pad 20 for inputting a secret number by users in direct, a storage unit 50 for storing information on a card and a joint store, information exchanged with a host 120 and particulars of dealing, a security module 100 for performing storage of a security key and operation of a password, a printer 60 for outputting the particulars of dealing, a display unit 70 for displaying a state of operation, a control unit 110 not only for storing temporarily information on a card read from the IC card and MS card interface units 40 and 30 to the storage unit 50 according to values inputted from the key input unit 10 and the pin pad 20, but also for processing the values stored to the storage unit 50 and the security module 100 and then transmitting it to the host 120, and for outputting information transmitted from the host to the printer 60 and the display unit 70, and a modem 80 for connecting the control unit 110 with the host 120 through a telecommunication network, thereby capable of exchanging information.

In addition, a RS232C interface unit 90 for connecting the control unit 110 with external devices such as a machine of a check inquiry (not shown), a moneybox (not shown), and an external device (not shown), is mounted, thereby capable of performing additional functions.

And, the display unit 70 includes a first display unit 72 for displaying an operational state of the control unit 110 to an officer of a joint store, a second displaying unit 74 for displaying an operational state of the control unit 110 to a user, thereby capable of identifying contents relating to one easily.

And, the security module 100, as a SAM(Security Application Module), is a security means being used in electronic money of dealings and composed of a SSAM for storing an encryption key and mounted at the host 120, a CSAM mounted at a VAN company, and a PSAM mounted at a card reader. According to this, the security module performs a reciprocal authentication, identifies whether there is an alteration and a forgery of the electronic money or not, and performs an operation of a secret code in order to be secured financial services of dealings logically and physically.

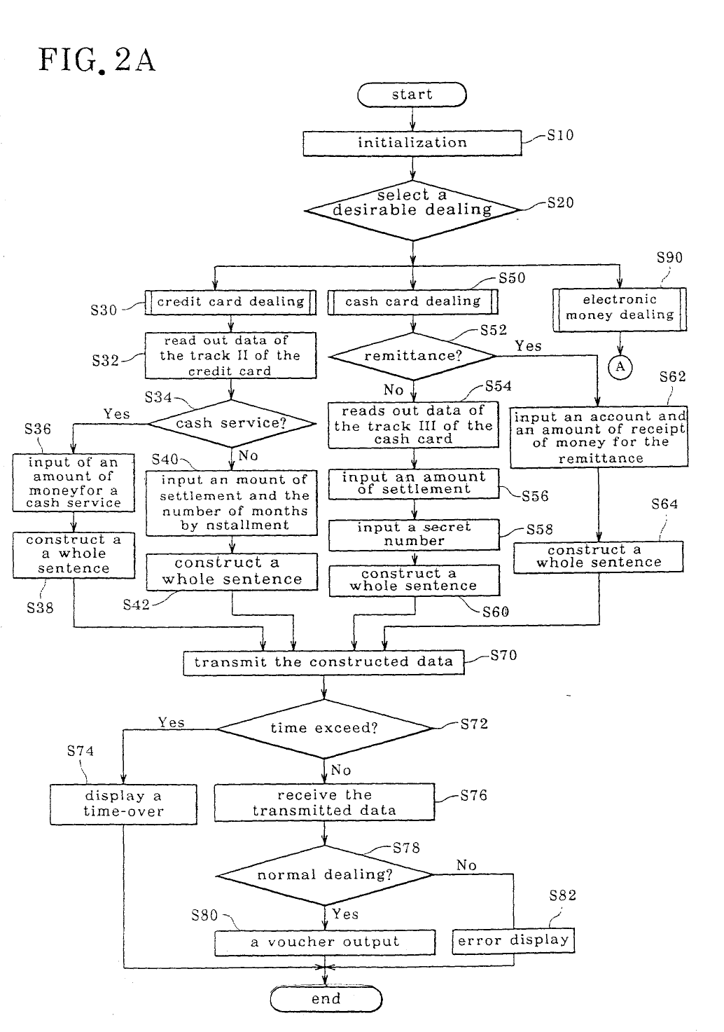

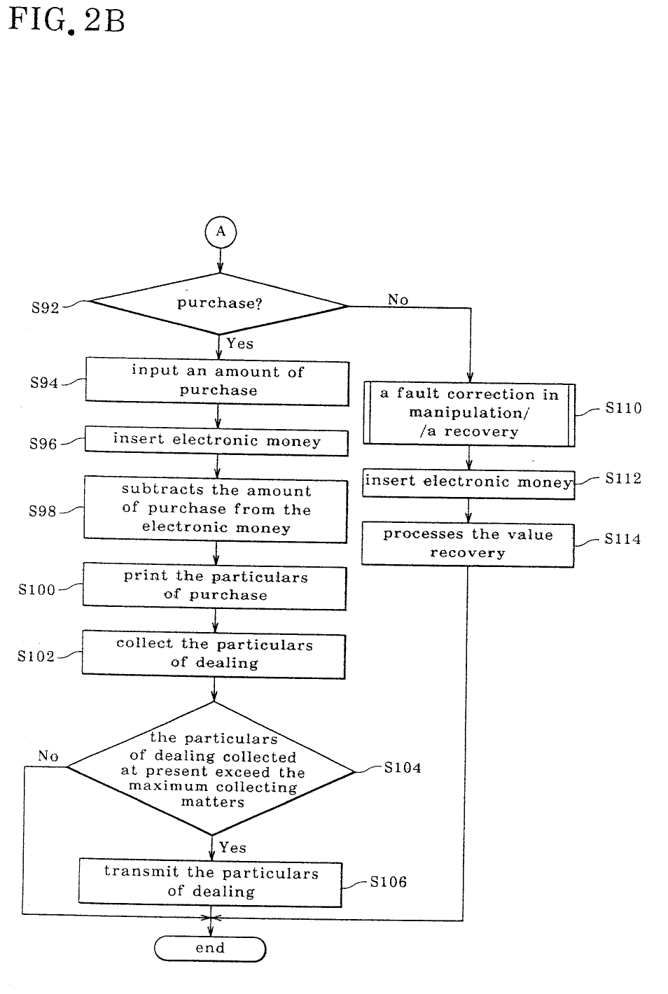

An operation of the card reader integrated financial services as mentioned above will be described in accompanying with FIGS. 2a and 2b, which are flow charts for explaining an operation of the card reader integrated financial services in accordance with the present invention.

First, a card reader for a normal operation is initialized in step S10. Thereafter, at an initial screen, a user selects a desirable dealing through a key input unit 10 in step S20. That is, the user selects a desirable dealing such as a credit card, a money card, electronic money, a totalization and exact calculation, and a dealing of inquiry, etc. The functions of the totalization and exact calculation and a dealing of inquiry are in the general terminal and so the explanation on those things will be omitted.

On the other hand, in a case of connecting a machine of a check inquiry (not shown) to the card reader through the RS232C interface unit 90, dealing required a check inquiry could select.

As above, in a case of selecting a dealing of a credit card in step S30, when passing the credit card through a MS card interface unit 30, the card reader reads out data of the track II of the credit card and stores the data to a storage unit 50 temporarily in step S32. Thereafter, the card reader requires selecting one among dealings for purchasing of goods and requiring a cash service in step S34.

At this time, in a case of selecting dealing of a cash service, a desirable amount of money to be received a cash service is inputted to the card reader in step S36.

After receiving the amount of money for receiving a cash service, the card reader constructs a whole sentence together with the account of dealing of a joint store, which is stored to the storage unit 50 and transmits the constructed data to the host 120 through a modem 80 in steps S58 and S70.

Thereafter, in a case that the data do not transmitted from the host 120 after passing a constant time, a time-over is displayed to a display unit 70 and then the processes are finished in steps S72 and S74. However, if the data is transmitted from the host 120 within a constant time, the card reader receives the transmitted data in steps S72 and S76.

At this time, after comparing whether contents of the received data is a normal dealing or not, in a case of a normal dealing, the card reader issues a voucher through a printer 60 and then the processes are finished in steps S78 and S80. However, in a case of an abnormal dealing, the card reader displays an error state through the display unit 70 and then the processes are finished in steps S78 and S82.

And, in a case of dealing for purchasing goods among credit card dealings in step S34, an amount of payment and the number of months by installment are inputted in step S40. Thereafter, like a credit dealing in general, the card reader constructs a whole sentence and transmits the constructed data to the host 120 through a modem 80 and receives the results processed from the host 120 and outputs the results of dealing to the printer 60 and the display unit 70 and then the processes are finished in steps S42 and S70˜S82.

As mentioned above, in a case of dealing for purchasing goods among the credit card dealings, it is the same as the dealing of a general credit card, however, in a case of dealing a cash service, money received through the cash service can be remitted to an account of a joint store and so a user can draw the money in the joint store.

On the other hand, after initializing the card reader, a user selects a cash card dealing in step S50 and then remittance dealing, and thereafter the user inputs an account and an amount of receipt of money for the remittance to the card reader in steps S52 and S62. Thereafter, the card reader constructs a whole sentence for remittance of money from the account of dealing of a joint store, which is stored to the storage unit 50, to the account of receipt of money at once in step S64.

The constructed whole sentence like this is transmitted to the host 120 through a modem 80 in step S70. Thereafter, in a case that data do not transmitted from the host 120 after passing a constant time, a time-over is displayed to the display unit 70 and finished in steps S72 and S74. However, if data are transmitted from the host 120 within a constant time, the card reader receives the transmitted data in steps S72 and S76.

At this time, a step of comparing is processed whether contents of the received data is the same as that of a normal dealing or not, and then in a case of a normal dealing, the card reader issues a voucher and the processes are finished in steps S78 and S80. However, in a case of an abnormal dealing, the card reader displays an error state through the display unit 70 and then the processes are finished in steps S78 and S82.

And, in a case that a user selects dealings for purchasing goods or drawing money in the cash card dealing in step S52, that is, in a case that the user does not select a remittance dealing, when passing the cash card through the MS card interface unit 30, the card reader reads out data of the track II of the cash card and stores the data to the storage unit 50 temporarily in step S54.

Thereafter, the card reader receives an amount of settlement or drawing money in step S56 and a secret number of the cash card through a pin pad 20 in step S58. The card reader constructs a whole sentence for a remittance of money from the account of cash card to the account of dealing of the joint store through the received money as above, the secret number, card information stored to the storage unit 50 and joint store information in step S60 at once.

Next, after the whole sentence constructed as above is transmitted to the host 120 through the modem 80 in step S70, in a case that data do not transmitted from the host 120 after passing a constant time, a time-over is displayed to the display unit 70 and then the processes are finished in steps S72 and S74. However, if data is transmitted from the host 120 within a constant time, the card reader receives the transmitted data in steps S72 and S76.

At this time, a step of comparing is processed whether contents of the received data is the same as that of a normal dealing or not, and then in a case of a normal dealing, the card reader issues a voucher and the processes are finished in steps S78 and S80. However, in a case of an abnormal dealing, the card reader displays an error state through the display unit 70 and then the processes are finished in steps S78 and S82.

As above, in a case that a user purchases goods or draws money at a joint store through a cash card, not use an ATM machine, since the money is remitted from the account of the cash card to the account of dealing of the joint store at once, the user can pay the price of goods, that is, can deal drawing of money at the joint store.

And, after initializing the card reader, in a case that a user selects electronic money dealing in step S90 and then dealing for purchasing goods, the user inputs an amount of money for purchasing goods in steps S92 and S94. Then, when inserting the electronic money into an IC card interface unit 40, the card reader subtracts the value of the purchase price from the value stored to the electronic money in steps S96 and S98. Thereafter, the particulars of purchase are outputted through a printer 60 and then the particulars of dealings are collected to a security module 100 in steps S100 and S102. And, the card reader compares whether the particulars of dealing stored to the security module 100 exceed the maximum collecting matters in step S104. At this time, in a case that the particulars of dealing do not exceed the maximum collecting matters, the previous processes are finished. However, in a case that the particulars of dealing exceed the maximum collecting matters, the particulars of dealing stored to the security module 100 is automatically transmitted to the host 120 through the modem 80 and then the previous processes are finished in step S106.

And, in the dealing of electronic money, in a case that a user selects a correction of fault in manipulation or a recovery of an error in step Silo, that is, does not select a purchase dealing, when the electronic money is inserted through the IC card interface unit 40, the card reader operates a value recovery process by comparing it to the particulars of dealing stored to the security module 100 and then the processes are finished in steps S112 and S114.

As mentioned above, although in a case that the particulars of dealing exceeds the maximum collecting matters, the particulars of dealing is automatically transmitted to the host 120, the user can transmit the particulars of dealing optionally.

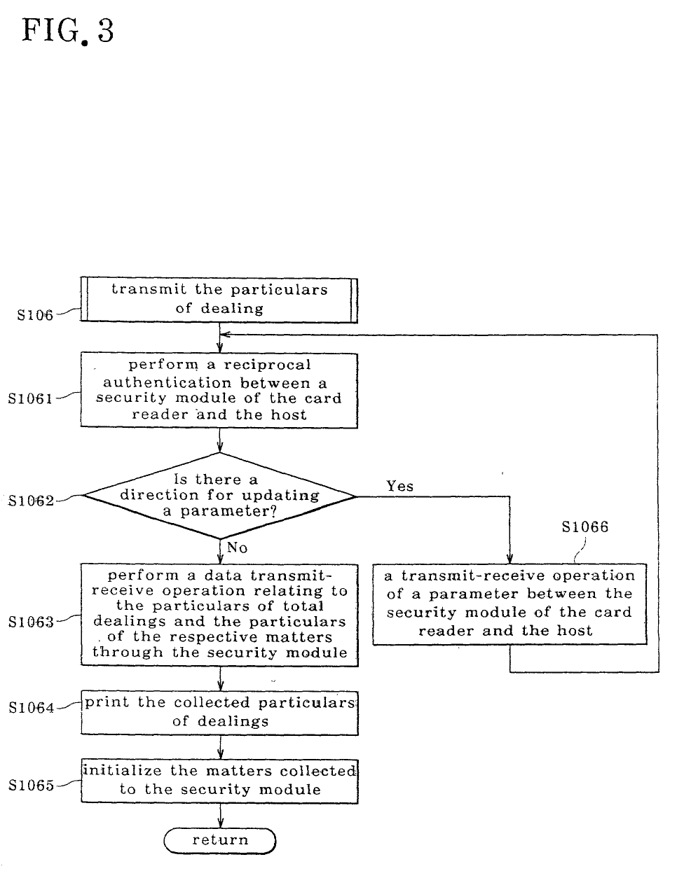

FIG. 3 is a flow chart for explaining transmission of the particulars of dealings when dealing electronic money in a card reader integrated financial services in accordance with the present invention.

First, in a state that the card reader is connected with a host 120 through a modem 80, a data transmit-receive operation is performed between a security module 100 of the card reader and the host 120 for the reciprocal authentication in step S1061.

Thereafter, the card reader compares that whether there is a direction for updating a parameter of the security module 10 from the host 120. At this time, if there is a direction for updating a parameter, a data transmit-receive operation is performed between the security module 100 of the card reader and the host 120 for updating a parameter, and then the parameter is updated in step S1066 and thereafter the process is returned to the authentication step S1061.

However, if there is not the direction for updating the parameter, the card reader transmits the particulars of total dealing by the electronic money collected to the security module 100 and the particulars of the respective matters in step S1063. Thereafter, the card reader outputs the collected particulars of dealing through a printer 60 in step S1064. And, the matters collected to the security module 100 are initialized in step S1065 and thereafter the process is returned.

As mentioned above, when updating the parameter, although a communication between the security module of the card reader and the host is automatically performed, in a case that the user selects optionally the parameter update, such as in a case that the code of a purchasing bank is changed, the work for updating the parameter of the security module 100 can be performed.

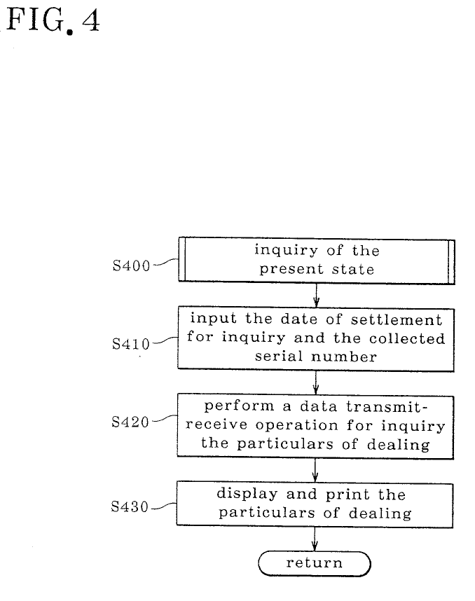

On the other hand, as shown in FIG. 4, in dealing of an electronic money, the step for inquiry the state of particulars of dealing of the electronic money collected to the KFTC(Korea Financial Telecommunications and Clearings institute) is further included in step S400.

That is, in step S410, the date of settlement for inquiry and the collected serial number are inputted and then the inputted values are transmitted to a host in step S420. Then, according to the data transmit-receive operation between the host and the KFTC is performed, the particulars of dealing through the data transmit-receive operation is transmitted to the card reader, thereby outputting the data received to the card reader through the display unit 70 or the printer 60 in step S430.

As mentioned above, the present invention supports dealings with a credit card, a cash card, and an electronic money through the card reader integrated financial services mounted to a joint store and so commercial dealings can perform without cash and also the banking work can perform without visiting a bank.

There are also several advantages that not only the purchase of products by using a credit card, but the remittance of the money provided by cash service to the account of a joint store through the card reader integrated financial services mounted on the joint store are possible, as a result, the user can receive the money, that is, a cash service, remitted to the account of the joint store without visiting a bank.

And, through the card reader integrated financial services mounted on the joint store, a user can remit the money from one's own account of the cash card to the account of the joint store by using a cash card and so not only the user can pay the price of a product and but the user can draw the money deposited to a bank at the joint store positioned at the neighborhood without using an ATM machine, as a terminal for a cash card of a bank.

On the other hand, through the card reader integrated financial services mounted on the joint store, the user can subtract, transmit and inquiry the state in using an electronic money by an IC card.

As the present invention may be embodied in several forms without departing from the spirit or essential characteristics thereof, it should also be understood that the above-described embodiment is not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A card reader integrated financial services comprising:
an IC card interface means for communicating with an IC card each other,
a MS card interface means for reading data recorded on a MS card,
a key input means for inputting a key in order to select or operate a menu,
a pin pad for inputting a secret number by users in direct,
a storage means for storing information on a card and a joint store, information exchanged with a host and particulars of dealing,
a security module means for performing storage of a security key and operation of a password,
a printer for outputting the particulars of dealing,
a display means for displaying a state of operation,
a control means not only for storing temporarily information on a card read from the IC card and MS card interface means to the storage means according to values inputted from the key input means and the pin pad, but also for processing the values stored to the storage means and the security module and then transmitting it to the host, and for outputting information transmitted from the host to the printer and the display means, and
a modem means for connecting the control means with the host through a telecommunication network, thereby capable of exchanging information.

2. The card reader integrated financial services according to claim 1, wherein the card reader further comprises:
a RS232C interface means for connecting the control means with a machine of a check inquiry, a moneybox, and an external device.

3. The card reader integrated financial services according to claim 1, wherein the display means includes a first display means for displaying an operational state of the control means to an officer of a joint store,
a second displaying means for displaying an operational state of the control means to a user, thereby capable of identifying contents relating to one easily.

4. A method for operating a card reader integrated financial services comprising:
a step of initializing the card reader,
a step of selecting desirable dealings through a key input means after initializing the card reader,
a step of constructing a whole sentence, in a case that a credit card dealing is selected after initializing the card reader, through data of track II of the credit card, of a storage means and inputted by the key input means in order to perform dealings such as a purchasing of goods and a cash service,
a step of constructing a whole sentence, in a case that a cash card dealing is selected after initializing the card reader, through data of track III of the cash card, of a storage means and inputted by the key input means in order to perform dealings such as a remittance of the price of goods and draw money,
a step of transmitting the constructed whole sentence to a host through a modem in order to perform dealings such as the credit and cash cards,
a step of displaying the result of dealing to a display means and outputting it to a printer by receiving the data transmitted from the host,
a step of calculating, in a case that an electronic money dealing is selected after initializing the card reader, the value of the electronic money through data of the electronic money, a security module, and the key input means, and collecting the particulars of dealing,
a step of automatically transmitting the particulars of dealing in a case that the number of collected particulars of dealings exceeds the maximum collecting matters.

5. The method for operating a card reader integrated financial services according to claim 4, wherein the whole sentence for a cash service in a credit card dealing is constructed through the amount of the cash service inputted by the key input means, the account of the joint store stored to the storage means, and the data of the credit card.

6. The method for operating a card reader integrated financial services according to claim 4, wherein the whole sentence for remitting the price of goods and drawing money in a cash card dealing is constructed through the price of purchasing and money of drawing inputted by the key input means, the account of the joint store stored to the storage means, the account recorded to the cash card, and a secret number inputted by a key pad.

7. The method for operating a card reader integrated financial services according to claim 4, wherein the whole sentence for remitting money in a cash card dealing is constructed through the amount of remittance and the account for receiving money inputted by the key input means, and the account of the joint store stored to the storage means.

8. The method for operating a card reader integrated financial services according to claim 4, wherein the step of calculating, in a case that an electronic money dealing is selected, the value of the electronic money, and collecting the particulars of dealing, further comprises:
a step of inputting the amount of money for purchasing goods,
a step of subtracting the values of the amount of purchase from the value stored in the electronic money inserted through an IC card interface means,
a step of outputting the particulars of purchase through a printer, and
a step of collecting the particulars of dealing to a security module.

9. The method for operating a card reader integrated financial services according to claim 4, wherein the method further comprises:
a step of operating, in electronic money dealing, a correction of fault in manipulation or a recovery of an error, by comparing the electronic money inserted through the IC card interface means to the particulars of dealing stored to the security module.

10. The method for operating a card reader integrated financial services according to claim 4, wherein when transmitting the particulars of dealing, the user can transmit it optionally.

11. The method for operating a card reader integrated financial services according to claim 4 or 10, wherein the method, when transmitting the particulars of dealing, further comprises:
a step of authenticating reciprocally between the security module of the card reader and the host,
a step of comparing that whether there is a direction for updating a parameter of the security module from the host,
a step of, if there is a direction for updating a parameter, performing a data transmit-receive operation between the security module of the card reader and the host for updating a parameter, updating the parameter and thereafter returning the process to the authentication step, if there is not the direction for updating the parameter, performing a data transmit-receive operation the particulars of total dealing by the electronic money collected to the security module and the particulars of the respective matters, and
a step of outputting the collected particulars of dealing through a printer and then initializing the matters collected to the security module.

12. The method for operating a card reader integrated financial services according to claim 11, wherein in a case that the user selects optionally the parameter update, the work for updating the parameter of the security module can be performed.

13. The method for operating a card reader integrated financial services according to claim 4, wherein, when selecting an electronic money dealing, the method further comprises:
a step for inquiry the state of particulars of the electronic money dealing collected to the KFTC(Korea Financial Telecommunications and Clearings institute).

14. The method for operating a card reader integrated financial services according to claim 13, wherein the step of inquiry the state of particulars of dealing further comprises:
a step of inputting the date of settlement for inquiry and the collected serial number,
a step of transmitting the inputted values to the host,
a step of performing a data transmit-receive operation between the host and the KFTC, and receiving the particulars of dealing and then outputting the data to a display means or a printer.
